(19) United States
(12) Patent Application Publication
(10) Pub. No.: US 2025/0375027 A1
(43) Pub. Date: Dec. 11, 2025

(54) TOOL SYSTEM FOR APPLYING AND MANIPULATING PAINT AND CHARCOAL

(71) Applicant: Brian Glover, Midland, MI (US)

(72) Inventor: Brian Glover, Midland, MI (US)

(21) Appl. No.: 18/735,397

(22) Filed: Jun. 6, 2024

(51) Int. Cl. A46B 5/00; B44D 2/00

(52) U.S. Cl. CPC A46B 5/0095; B44D 2/002; A46B 2200/205

(57) ABSTRACT

An art production tool system for applying, manipulating, or removing paint, charcoal, and other art media includes a handle and a plurality of attachments which are interchangeably mountable to the handle. The attachments include at least one blender attachment comprising chamois leather or similar material for blending and removing charcoal and like applications. The attachments also include brushes and may include other tools for manipulating paint, dyes, charcoal, and the like.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to art media manipulation tools and more particularly pertains to a new art media manipulation tool for applying, manipulating, or removing paint, charcoal, and other art media.

### (2) Description of Related Art Including Information Disclosed Under 37 CFR 1.97 and 1.98.

The prior art relates to art media manipulation tools such as brushes, blender tools, scrapers, and the like. The prior art discloses tool systems in which various brushes or other applicators are interchangeably mountable to a handle. The prior art also describes tools made of silicone or similar for removing controlled amounts of paint or other art media. It is also known to the art that chamois leather and similar materials may be used to blend charcoal or otherwise manipulate art media. However, the prior art fails to describe such a tool system in which various attachments including those with chamois leather heads are interchangeably mountable to a handle.

### BRIEF SUMMARY OF THE INVENTION

An embodiment of the disclosure meets the needs presented above by generally comprising a handle with a base end and an attachment end. Each of a plurality of attachments is interchangeably mountable to the attachment end of the handle. Each attachment of the plurality of attachments is configured to apply or manipulate art media like paint or charcoal on a substrate such as canvas or paper. Each attachment of the plurality of attachments comprises a base and a head which are coupled to each other. The base is attachable to the handle, and the head is configured to apply, manipulate, or remove the art media. The plurality of attachments includes a blender attachment, the head of which comprises a pliable material. The head of the blender attachment may be used in particular to blend charcoal or otherwise manipulate art media. Other attachments may include brushes, scrapers, or other such art tools.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a tool assembly of an art production tool system according to an embodiment of the disclosure.

FIG. 2 is a front view of a tool assembly of an embodiment of the disclosure. A partial cross section shows an interior of a handle.

FIG. 3 is an exploded view of a handle and an attachment of an embodiment of the disclosure.

FIG. 4 is an exploded view of a handle and an attachment of an embodiment of the disclosure.

FIG. 5 is a front view of a tool assembly of an embodiment of the disclosure. A partial cross section depicts an interior of an attachment for the tool assembly.

FIG. 6 is a cross section view of an embodiment of the disclosure taken from Line 6-6 in FIG. 5.

FIG. 7 is a kit view of a plurality of blender attachments of an embodiment of the disclosure.

FIG. 8 is an in-use view of a tool assembly of an embodiment of the disclosure.

### DETAILED DESCRIPTION OF THE INVENTION

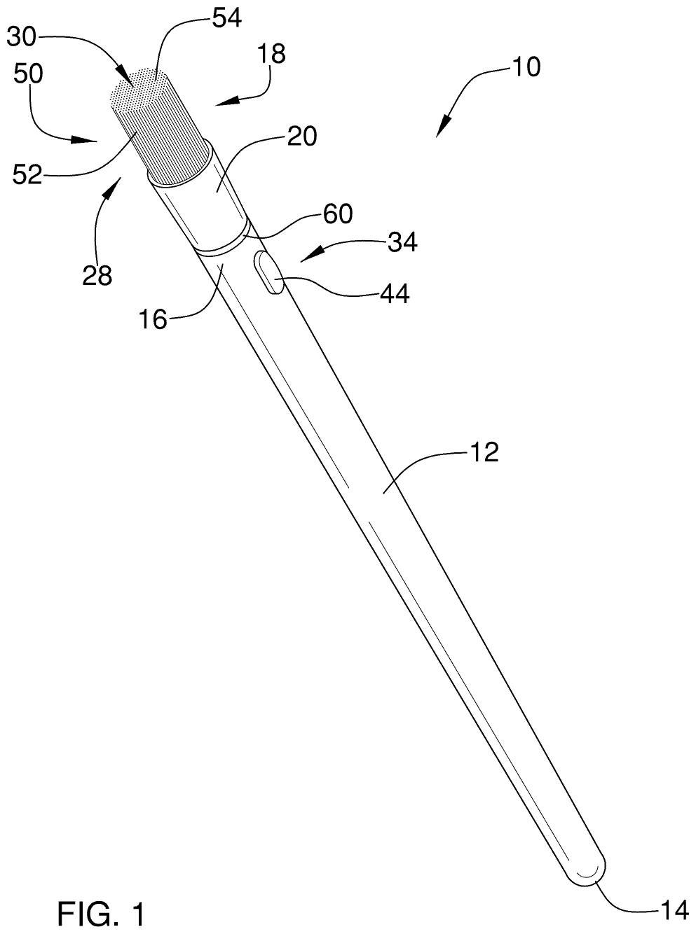

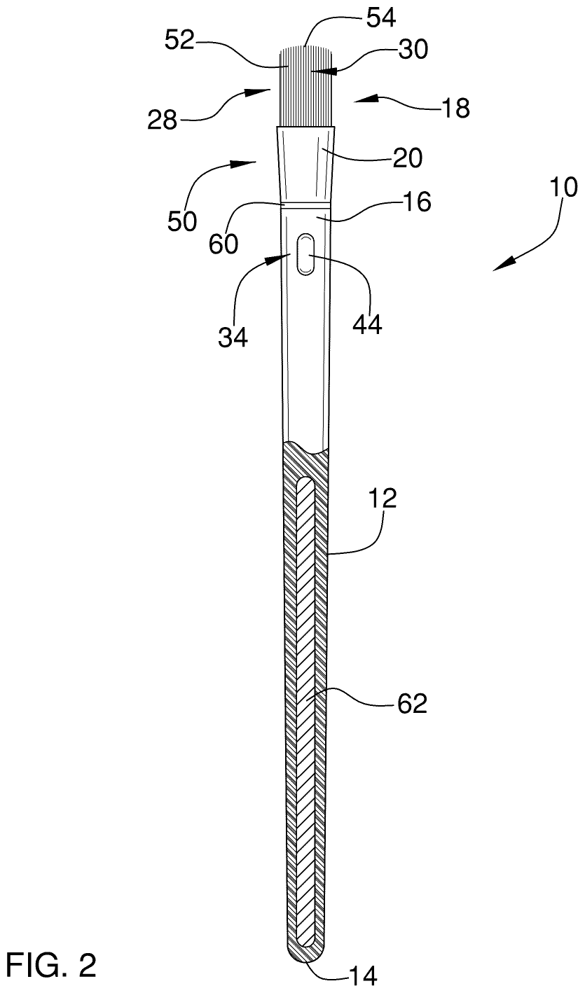

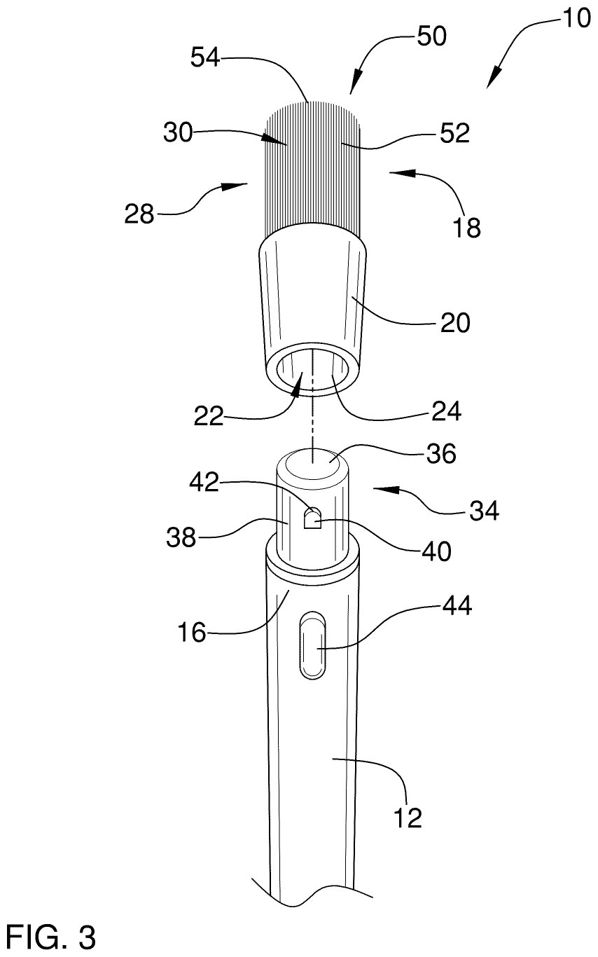

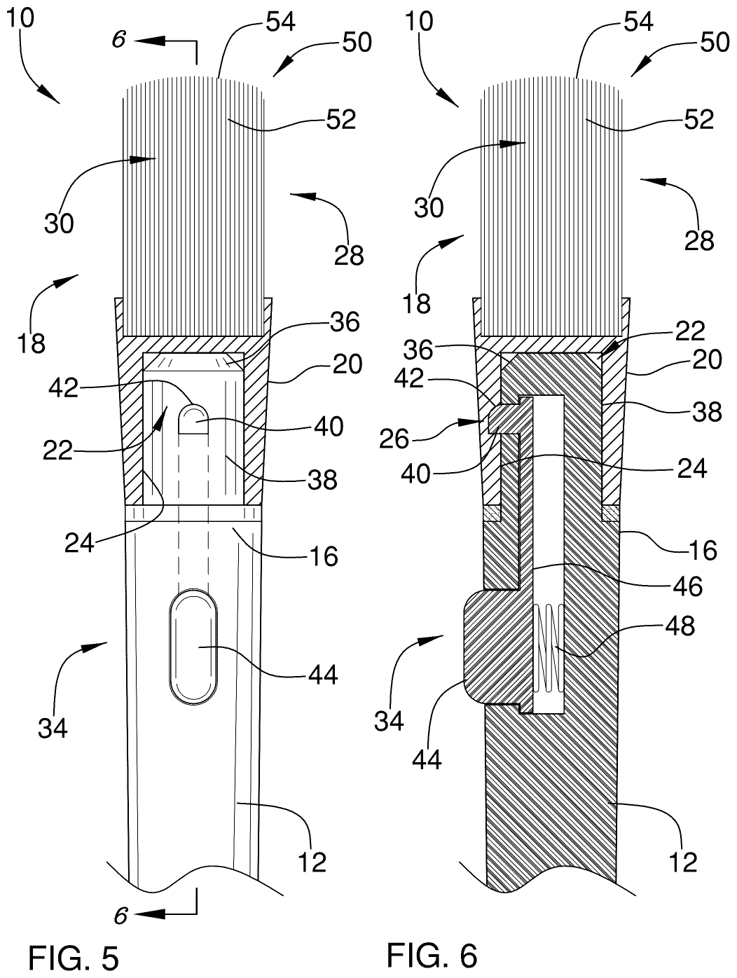

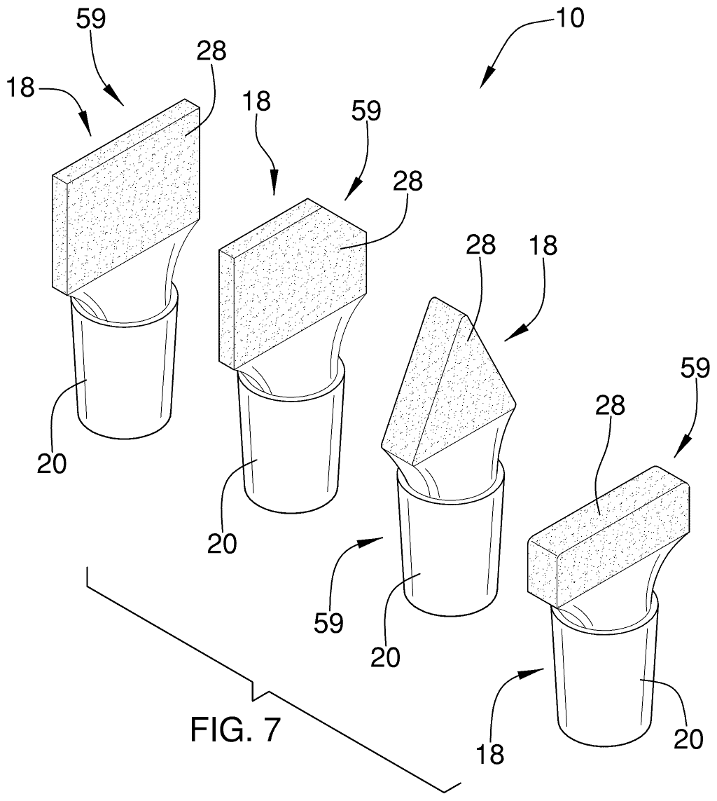

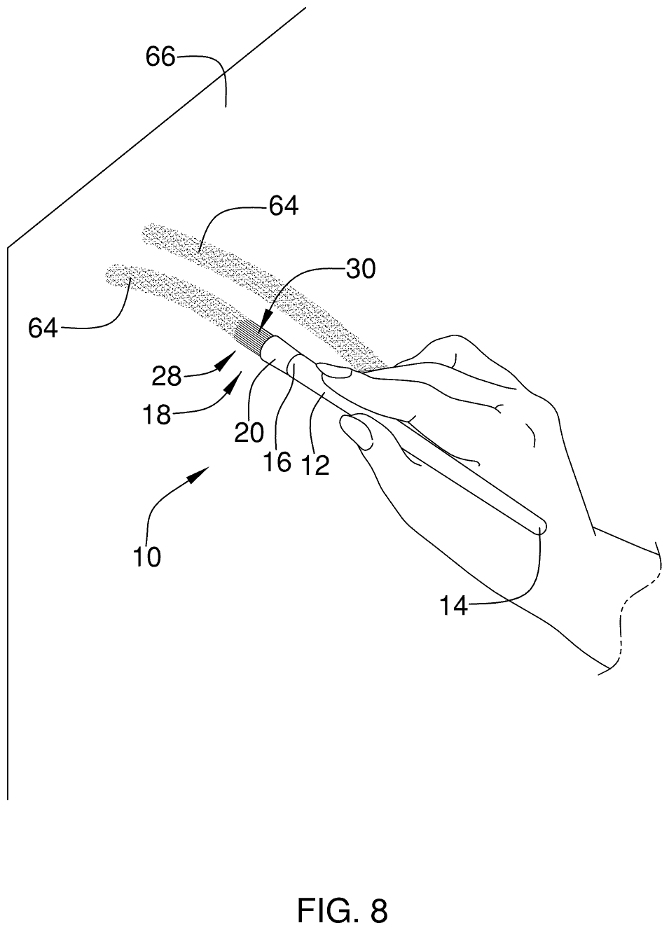

With reference now to the drawings, and in particular to FIGS. 1 through 8 thereof, a new art media manipulation tool embodying the principles and concepts of an embodiment of the disclosure and generally designated by the reference numeral 10 will be described.

As best illustrated in FIGS. 1 through 8, the art production tool system 10 generally comprises a handle 12 which is elongated between a base end 14 and an attachment end 16. Attachments 18 are interchangeably mountable to the attachment end 16 of the handle 12 via a fastener 34. Each attachment 18 is configured to apply or manipulate art media 64 such as paint, charcoal, ink, dyes, or the like. Each attachment 18 comprises a base 20 and a head 28 which are coupled to each other. The base 20 defines a cavity 22 opposite the head 28 and a notch 26 on an interior surface 24 in the cavity 22.

The fastener 34 is coupled to the handle 12 at the attachment end 16. The fastener 34 comprises an insert 36 which is shaped to be receivable into the cavity 22 of the base 20 of any of the attachments 18. The fastener 34 also includes a locking protrusion 40 which is movably mounted to a perimeter 38 of the insert 36. The locking protrusion 40 is movable alternately inwardly and outwardly of the insert 36 and is biased outwardly of the insert 36. The locking protrusion 40 is received into the notch 26 of the base 20 of a selected attachment 18 of the plurality of attachments 18 when the selected attachment 18 receives the insert 36 into the cavity 22 of the base 20. The locking protrusion 40 is biased to remain in the notch 26, thereby securing the selected attachment 18 to the handle 12. The locking protrusion 40 has a sloped corner 42 facing away from the attachment end 16 of the handle 12 such that the attachments 18 may urge the locking protrusion 40 into the insert 36 when colliding with the locking protrusion 40 as the insert 36 is received into the attachment 18. The sloped corner 42 is rounded but may comprise a slanted planar surface, a flared surface, or another suitable shape.

The fastener 34 also includes a button 44 which is movably mounted to the handle 12 and is operably coupled to the locking protrusion 40. The button 44 is depressible into the handle 12 to move the locking protrusion 40 inwardly of the insert 36. The button 44 and the locking protrusion 40 are integrally formed along with an attachment arm 46 that extends between the button 44 and the locking protrusion 40. In other embodiments, however, the button 44 may be operably joined to the locking protrusion 40 by a lever, a linkage, or other suitable mechanism. A compression spring 48 is mounted in the handle 12 which biases both the button 44 and the locking protrusion 40 out of the handle 12 and the insert 36 respectively. Other biasing means may be used such as an elastic band, a torsional spring, or the like.

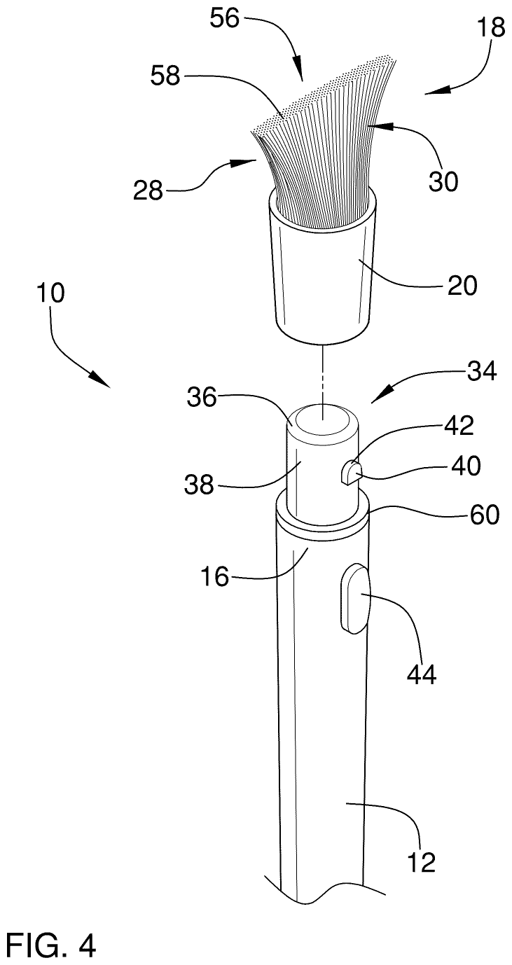

The plurality of attachments 18 includes a plurality of brush attachments and a plurality of blender attachments 59. The head 28 of each brush attachment comprises a plurality of pliable bristles 30, and the pliable bristles 30 of the brush attachments form different shapes with respect to each other. For example, FIGS. 1-3, 5, and 6 depict a first brush attachment 50 in which the pliable bristles 30 form a cylindrical shape 52 with a rounded end 54, forming what is known to the art as a Filbert brush. FIG. 4 presents a second brush attachment 56 in which the pliable bristles 30 form a fan shape 58. Other brush attachments with suitable forms may also be used, including common forms known to the art like flat shaders, angular shaders, wash/glaze brushes, round brushes, liner brushes, spotter brushes, quill brushes, and the like. The brush attachments may be used to apply and manipulate paint as well as any other suitable use for brushes known to the art. The paint or other art media 64 may be applied to any suitable substrate 66 such as canvas, paper, pottery, or the like.

The head 28 of each blender attachment 59 comprises chamois leather 32, which is especially suited for blending and removing charcoal, but may be used for any suitable purpose known to the art. The chamois leather 32 preferably has a textured exterior surface and has a pliability that allows the chamois leather 32 to compress when pressed against the substrate 66. The textured exterior surface defines pitted regions, dimples, ridges, or the like which causes charcoal or other applications to the substrate to be deposited or moved in an uneven manner over the substrate. This application process may result in blending the charcoal or other application in a desirable manner on the substrate. The texture of the exterior surface of the chamois leather 32 may be irregular or conform to a particular pattern or design in various embodiments.

Other similar materials may also be used in various embodiments. For example, microfiber has been used to imitate chamois leather 32 in a product sometimes referred to as a “shammy.” The term “shammy” is also used in some cases to refer to chamois leather rather than the imitation product. The present disclosure also contemplates the use of chamois leather or other material with a smooth exterior surface, although visual results will vary from those described above when using such materials. FIG. 7 depicts several blender attachments 59 with heads 28 of various different shapes. The head 28 of any of the blender attachments 59 may have any suitable shape.

A gasket 60 is coupled to the attachment end 16 of the handle 12 and surrounding the insert 36 of the fastener 34. The gasket 60 is positioned to form a seal with the base 20 of a selected attachment 18 of the plurality of attachments 18 is mounted to the handle 12, thereby preventing substances such as paint, water, oils, and the like from seeping between the selected attachment 18 and the insert 36. The gasket 60 may comprise rubber, silicone, or any other suitable sealing material. A weight 62 is mounted in the handle 12 and is positioned closer to the base end 14 than the attachment end 16 in order to shift a center of gravity of the handle 12 toward the base end 14.

In use, any of the attachments 18 may be mounted to the attachment end 16 of the handle 12. The button 44 may be depressed to disengage the locking protrusion 40 from the selected attachment 18 to release the selected attachment 18 and choose another attachment 18 to mount to the handle 12. With one of the attachments 18 mounted to the handle 12, the assembled tool may be used to apply, manipulate, and remove art media 64 such as paint, charcoal, ink, dyes, water, oil, or the like to define an image upon a chosen substrate 66.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An art production tool system for applying and manipulating art media on a substrate, the system comprising:
a handle, the handle having a base end and an attachment end; and
a plurality of attachments, the attachments of the plurality of attachments being interchangeably mountable to the attachment end of the handle, each attachment of the plurality of attachments being configured to apply or manipulate art media on the substrate, each attachment of the plurality of attachments comprising a base and a head which are coupled to each other, the plurality of attachments including a blender attachment, the head of the blender attachment comprising a pliable material.

2. The system of claim 1, wherein the pliable material of the blender attachment has a textured exterior surface.

3. The system of claim 1, wherein the blender attachment is one of a plurality of blender attachments, the heads of the blender attachments forming different shapes with respect to each other.

4. The system of claim 1, wherein the plurality of attachments includes a brush attachment, the head of the brush attachment comprising a plurality of pliable bristles.

5. The system of claim 4, wherein the brush attachment is one of a plurality of brush attachments, the pliable bristles of the brush attachments forming different shapes with respect to each other.

6. The system of claim 1, further comprising a fastener coupled to the handle at the attachment end, the fastener being configured to interchangeably mount the attachments to the handle.

7. The system of claim 6, wherein:
the base of each attachment defines a cavity opposite the head; and
the fastener comprises an insert coupled to and protruding away from the attachment end of the handle, the insert being receivable into the cavity of the base of each attachment.

8. The system of claim 7, wherein:
the base defining a notch on an interior surface in the cavity; and
the fastener further comprises a locking protrusion mounted on a perimeter of the insert, the locking protrusion being movable alternately inwardly and outwardly of the insert, the locking protrusion being receivable in the notch of the base of each attachment when the insert is received into the cavity of the base, the locking protrusion being biased outwardly of the insert.

9. The system of claim 8, wherein the locking protrusion has a sloped corner facing away from the attachment end of the handle.

10. The system of claim 8, wherein the fastener further comprises a button movably mounted to the handle and operably coupled to the locking protrusion, the button being depressible into the handle to move the locking protrusion inwardly of the insert.

11. The system of claim 7, further comprising a gasket coupled to the attachment end of the handle and surrounding the insert of the fastener, the gasket being positioned to form a seal with the base of a selected attachment of the plurality of attachments is mounted to the handle.

12. The system of claim 1, further comprising a weight mounted in the handle, the weight being positioned closer to the base end than the attachment end.

13. The system of claim 1, wherein the handle being elongated between the base end and the attachment end.

14. The system of claim 1, wherein the pliable material of the blender attachment is chamois leather.

15. An art production tool system for applying and manipulating art media on a substrate, the system comprising:
a handle, the handle having a base end and an attachment end, the handle being elongated between the base end and the attachment end;
a plurality of attachments, the attachments of the plurality of attachments being interchangeably mountable to the attachment end of the handle, each attachment of the plurality of attachments being configured to apply or manipulate art media on the substrate, each attachment of the plurality of attachments comprising a base and a head which are coupled to each other, the base defining a cavity opposite the head, the base defining a notch on an interior surface in the cavity, the plurality of attachments including:
a plurality of brush attachments, the head of each brush attachment comprising a plurality of pliable bristles, the pliable bristles of the brush attachments forming different shapes with respect to each other; and
a plurality of blender attachments, the head of each blender attachment comprising a pliable material, the pliable material having a textured exterior surface, the heads of the blender attachments forming different shapes with respect to each other;
a fastener coupled to the handle at the attachment end, the fastener being configured to interchangeably mount the attachments to the handle, the fastener comprising:
an insert coupled to and protruding away from the attachment end of the handle, the insert being receivable into the cavity of the base of each attachment;
a locking protrusion mounted on a perimeter of the insert, the locking protrusion being movable alternately inwardly and outwardly of the insert, the locking protrusion being receivable in the notch of the base of each attachment when the insert is received into the cavity of the base, the locking protrusion being biased outwardly of the insert, the locking protrusion having a sloped corner facing away from the attachment end of the handle; and
a button movably mounted to the handle and operably coupled to the locking protrusion, the button being depressible into the handle to move the locking protrusion inwardly of the insert;
a gasket coupled to the attachment end of the handle and surrounding the insert of the fastener, the gasket being positioned to form a seal with the base of a selected attachment of the plurality of attachments is mounted to the handle; and
a weight mounted in the handle, the weight being positioned closer to the base end than the attachment end.
